(19) United States
(12) Patent Application Publication
(10) Pub. No.: US 2026/0197316 A1
(43) Pub. Date: Jul. 9, 2026

(54) SESSION TERMINATION OR AUTHORIZED COMPLETION BASED ON AUTHENTICATION ENTITIES

(71) Applicant: International Business Machines Corporation, Armonk, NY (US)

(72) Inventors: Paul Llamas Virgen, Guadalajara (MX); Priyansh Jaiswal, Boca Raton, FL (US); Doga Tav, Fredericton (CA)

(21) Appl. No.: 19/009,792

(22) Filed: Jan. 3, 2025

(51) Int. Cl. H04L 9/40

(52) U.S. Cl. CPC H04L 63/101; H04L 63/08

(57) ABSTRACT

A method, according to one embodiment, includes changing a first authentication entity associated with a first user's access to a restricted entity and a second authentication entity associated with a second user's access to the restricted entity. In response to a determination that the first user's access to the restricted entity includes the first user not currently running a query, a session of the first user's access to the restricted entity is terminated. In response to a determination that the second user's access includes the second user currently running a query, a determination is made as to whether the second user is listed in a privileged list of users and/or roles. In response to a determination that the second user is listed, a session of the second user's access to the restricted entity is allowed to continue and terminated upon completion of the second user's query.

### BACKGROUND

The present invention relates to security protocols, and more specifically, this invention relates to use of authentication entities.

When administrating a database, a user device may be used to routinely change passwords of users of the database. In some use cases, an expiry date is set on those passwords to trigger users to ongoingly change their passwords. This practice of changing such passwords protects the database from being accessed by unauthorized actors that might otherwise eventually gain access to stale (relatively old) passwords. Furthermore, this practice of changing passwords, in some jurisdictions, adheres to governing bodies which set governing standards for use of the database (e.g., such as instances where the database is used to store personal user information).

### SUMMARY

A method, according to one embodiment, includes changing a first authentication entity associated with a first user's access to a first restricted entity and a second authentication entity associated with a second user's access to the first restricted entity. In response to a determination that the first user's access to the first restricted entity includes the first user not currently running a query, a session of the first user's access to the first restricted entity is terminated based on the first authentication entity being changed. In response to a determination that the second user's access to the first restricted entity includes the second user currently running a query, a determination is made as to whether the second user is listed in a privileged list of users and/or roles. In response to a determination that the second user is listed in the privileged list of users and/or roles, a session of the second user's access to the first restricted entity is allowed to continue, and the session of the second user's access to the first restricted entity is terminated upon completion of the second user's query.

A computer program product, according to another embodiment, includes one or more computer readable storage media, and program instructions stored on the one or more storage media to perform the foregoing method.

A computer system, according to another embodiment, includes a processor set, one or more computer readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one

embodiment of the present invention.

FIG. 2 is a flowchart of a method, in accordance with one embodiment of the present invention.

FIG. 3 is a depiction of a network environment, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for selective session termination in response to changing authentication entities.

In one general embodiment, a method includes changing a first authentication entity associated with a first user's access to a first restricted entity and a second authentication entity associated with a second user's access to the first restricted entity. In response to a determination that the first user's access to the first restricted entity includes the first user not currently running a query, a session of the first user's access to the first restricted entity is terminated based on the first authentication entity being changed. In response to a determination that the second user's access to the first restricted entity includes the second user currently running a query, a determination is made as to whether the second user is listed in a privileged list of users and/or roles. In response to a determination that the second user is listed in the privileged list of users and/or roles, a session of the second user's access to the first restricted entity is allowed to continue, and the session of the second user's access to the first restricted entity is terminated upon completion of the second user's query.

In another general embodiment, a computer program product includes one or more computer readable storage media, and program instructions stored on the one or more storage media to perform the foregoing method.

In another general embodiment, a computer system includes a processor set, one or more computer readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as selective session termination code of block 150 for selective session termination in response to changing authentication entities. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

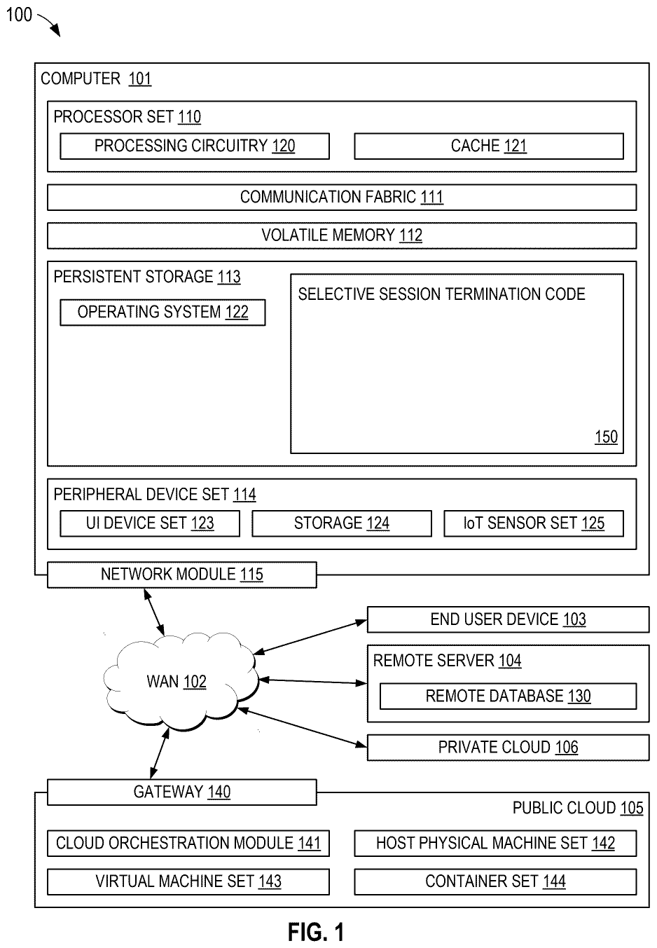

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, when administrating a database, a user device may be used to routinely change passwords of users of the database. In some use cases, an expiry date is set on those passwords to trigger users to ongoingly change their passwords. This practice of changing such passwords protects the database from being accessed by unauthorized actors that might otherwise eventually gain access to stale (relatively old) passwords. Furthermore, this practice of changing passwords, in some jurisdictions, adheres to governing bodies which set governing standards for use of the database (e.g., such as instances where the database is used to store personal user information).

Conventional password changes with respect to access to databases create security risks because users that are using user devices to perform a query during a session may be able to postpone enactment of the new password until the query is completed. The techniques of embodiments and approaches described herein mitigate these security risks by providing techniques for encapsulating current database transactions based on a dynamic query privileged list for scenarios where authentication entities (such as passwords) are changed and/or or updated via maintenance activities. This way, depending on activities of the user, determinations are made as to how to how to respond to the changes made to the authentication entities. For example, as will be described in greater detail elsewhere below, these responses may include, e.g., letting the user finish the query in that session and then requiring the user to use the new authentication entity for a next query, terminating the session as soon as the authentication entity is updated and/or expired and thereafter immediately requiring the user to use the new password, allowing the user to complete all the queries before enforcing the new authentication entity, maintaining and using a dynamically restricted query list (which may be enrichment based on metadata associated with the users and/or their queries), etc. For context, in some approaches, the techniques described herein do not necessarily focus on the security mechanism themselves (such as passwords, JSON Web Tokens (JWT), etc. Instead, these techniques prioritize when and which user's session to terminate upon authentication entities expiring. In order to make such determinations, the techniques herein analyze the running queries of user sessions.

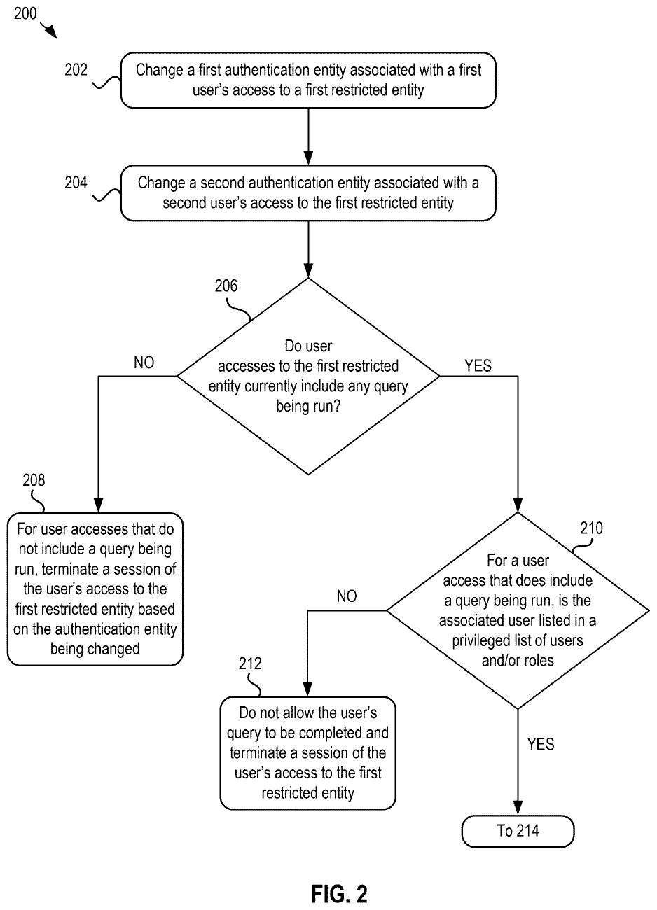

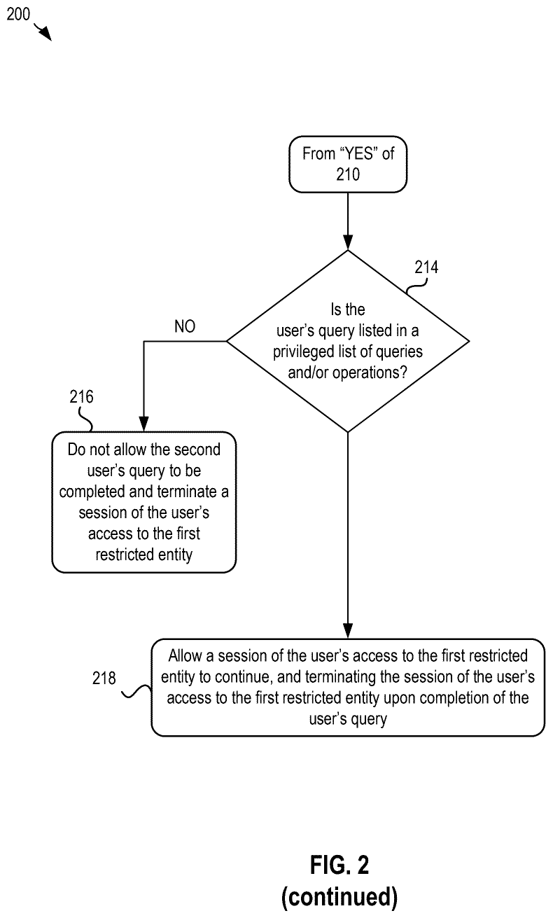

Now referring to FIG. 2, a flowchart of a method 200 is shown according to one embodiment. The method 200 may be performed in accordance with aspects of the present invention in any of the environments depicted in FIGS. 1-3, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 of method 200 includes changing a first authentication entity associated with a first user's access to a first restricted entity. Furthermore, a second authentication entity associated with a second user's access to the first restricted entity may additionally and/or alternatively be changed, e.g., see operation 204. For context, the term authentication entity mentioned in embodiment and approaches herein, e.g., “first authentication entity”, “second authentication entity”, etc., may be defined as any type of entity that can be used to access a restricted entity. Furthermore, in some approaches, the authentication entities described herein may be unique to a specific user, a type of user defined by employment responsibilities, a type of consumer defined by subscription plan type, etc. Various examples of the first authentication entity and the second authentication entity described herein may in some approaches, include, be selected from the group including a password, a token and a key. Other types of authentication entities that would become apparent to one of ordinary skill in the art after reading the descriptions herein may additionally and/or alternatively be used.

To provide further context, in some approaches, the first restricted entity may be defined as any location (physical and/or virtual) of resources, where user and/or user device access to the first restricted entity is controlled via current authentication entities. For example, in some approaches, the first restricted entity may be selected from the group including a data lake, a database, a document, an index, an application, and a server. Other authentication entities of a type that would become apparent to one of ordinary skill in the art after reading the descriptions herein may additionally and/or alternatively be used.

It should be noted that although various approaches described herein refer to use of the first authentication entity and the second authentication entity, depending on the approach, the techniques described herein may be modified to be performed with respect to any number of users, authentication entities and/or access to any number of restricted entities. For example, in one use case, the techniques described herein may be deployed with respect to a corporation that enacts different authentication entities for the employees of the corporation (where the first restricted entity is a server of the corporation).

In some approaches, the changes to the authentication entities, e.g., where the first authentication entity is changed to a third authentication entity and the second authentication entity is changed to a fourth authentication entity, may be made automatically, e.g., in response to a predetermined countdown expiring. In some other approaches, the changes may be performed in response to a predetermined type of threat event occurring, e.g., detection of a phishing attack, etc.

User devices may be used by the users to access the first restricted entity. For example, in response to a determination that the first authentication entity associated with the first user's access to the first restricted entity is entered into a user device used by the first user, a session of the first user's access to the first restricted entity session may be created. Similarly, in response to a determination that the second authentication entity associated with the second user's access to the first restricted entity is entered into a user device used by the second user, a session of the second user's access to the first restricted entity session may be created. However, users cannot use another user's authentication entity to create such a session, e.g., the second authentication entity does not grant the first user access to the first restricted entity and the first authentication entity does not grant the second user access to the first restricted entity.

The use of a user device to access the first restricted entity, in some approaches, includes performing a query. This query may be performed to use data on the first restricted entity, where the use may include operations including, e.g., deleting data, reading data, writing data, etc. Use of the user devices at any given time may be different among the different users. Accordingly, upon a change to a plurality of authentication entities, the user devices of the users may, in some approaches, be performing different tasks. For example, in one approach, a first user device of the first user may be connected to the first restricted entity and not running a query during the changing of the first authentication entity, and a second user device of the second user may be connected to the first restricted entity and running a query during the changing of the second authentication entity. These queries are preferably performed with respect to the first restricted entity, but may, in some other approaches, be queries performed with respect to any restricted entity (the first restricted entity, the second restricted entity, the third restricted entity, etc.). Different responses to the changing of authentication entities may be based on this potential for user devices of the users to be performing different tasks upon the authentication entities being changed (or alternatively not performing any task), as will now be described below.

In some approaches, a determination is made as to whether any user accesses to the first restricted entity currently include one or more queries being run, e.g., see decision 206. For example, a determination may be made (in response to changing the first authentication entity) as to whether the first user's access to the first restricted entity includes the first user not currently running a query, e.g., whether a user device of the first user currently connected to the first restricted entity is performing any query. Similarly, a determination is preferably additionally made (in response to changing the second authentication entity) as to whether the second user's access to the first restricted entity includes the second user not currently running a query, e.g., whether a user device of the second user currently connected to the first restricted entity is performing any query.

In response to a determination that the first user's access to the first restricted entity includes a user device of the first user currently connected to the first restricted entity and not currently running any a query, e.g., as illustrated by the “NO” logical path of decision 206, a session of the first user's access to the first restricted entity is terminated based on the first authentication entity being changed, e.g., see operation 208. Termination of the first user's access to the first restricted entity does not disrupt an active query and has a technical effect of renewing security of the first restricted entity by enacting a forced reauthentication of the first user before the first user is able to access the first restricted entity again.

In contrast to the above determination, in some approaches, with respect to one or more of the user accesses to the first restricted entity, a determination may be made that user access to the first restricted entity currently include a query being run. For example, in response to a determination that the second user's access to the first restricted entity includes the second user currently running at least one query, the session of the user's access to the first restricted entity may not (at least not solely based on the second authentication entity being updated) be terminated. Instead, in some approaches, in response to such a determination, a determination is made as to whether the second user is listed in a privileged list of users and/or roles. The privileged list of users and/or roles may, in some approaches, be stored in a configuration file associated with the first restricted entity. Furthermore, the privileged list of users and/or roles may, in some approaches, list names of specific users, list roles of role based access control schemes, list user profiles associated with users, etc.

The privileged list of users and/or roles may be used to determine whether the user's query should be interrupted, e.g., as a result of terminating the session, or be allowed to complete. For context, in some approaches, the privilege list may, based on predetermined factors such as job title, administrator status, user behavior, etc., define whether or not to interrupt a user's query. Method 200, in some approaches, includes generating and/or maintaining the privileged list of users and/or roles. For example, method 200, in some approaches, includes listing the first user in the privileged list of users and/or roles and monitoring the user's behavior to ensure that the user is not behaving in an unsafe manner. It should be noted that all monitoring performed with respect to user behavior is preferably only performed subsequent to gaining permission from the users, e.g., an opt-in clause. Furthermore, in some approaches, an artificial intelligence (AI) model is caused, e.g., instructed, to anonymously process the user behavior data.

In some approaches, the maintaining the privileged list of users and/or roles includes determining whether the user has used a user device to perform an action listed in a restricted list of risky user behaviors. For example, with respect to the first user, these action listed in the restricted list of risky user behaviors may, in some approaches, be selected from the group of actions including, e.g., using a work device for personal use, using the work device on an unsecure network, storing the first authentication entity in a file without password protection, and failing to correctly enter the first authentication entity while attempting to initiate the session of the first user's access to the first restricted entity. Other similar actions of a type that would become apparent to one of ordinary skill in the art after reading the descriptions herein may additionally and/or alternatively be listed in the restricted list of risky user behaviors. Furthermore, actions listed in the restricted list of risky user behaviors may, in some approaches, be dynamic in that the list may be updated at any time, e.g., by an administrator.

The maintaining the privileged list of users and/or roles, in some approaches, additionally and/or alternatively includes maintaining a count that details a number of times that a given user performs an action listed in the restricted list of risky user behaviors. For example, in one of such approaches, in response to a determination that the first user performs an action listed in a restricted list of risky user behaviors, a count (which may be specific to the first user and/or correspond to a plurality of users) may be added to. Furthermore, in some approaches, in response to a determination that a value of the count exceeds a predetermined threshold, the first user is removed from being listed in the privileged list of users and/or roles.

In some approaches, as a result of the first user being removed from being listed in the privileged list of users and/or roles, access to one or more other resources may additionally and/or alternatively be revoked. For example, user credentials and/or roles based access of the first user may at least temporarily be revoked based on the first user being removed from being listed in the privileged list of users and/or roles. In some approaches, a rollback occurs to instate previous privileges of the user in response to a determination that the first user has successfully performed a predetermined remediation action, e.g., taken a course on risky user behavior, gone a predetermined number of days without adding to the count, etc. In one approach, this rollback may include the first user being relisted in the privileged list of users and/or roles.

In some approaches in which the privileged list is used, in response to a determination that a user is not listed in the privileged list of users and/or roles a session of the user's access to the first restricted entity is preferably not allowed to continue, e.g., the session is terminated. Furthermore, an active query by such a user may additionally and/or alternatively be terminated. For example, in response to a determination that the second user is not listed in the privileged list of users and/or roles, the session of the second user's access to the first restricted entity is terminated based on the second authentication entity being changed, e.g., see operation 212. In contrast, a determination may be made that one or more of the users is listed in the privileged list of users and/or roles. For example, in response to a determination that the second user is listed in the privileged list of users and/or roles, e.g., as illustrated by the “YES” logical path of decision 210, a session of the second user's access to the first restricted entity is allowed to continue despite the second authentication entity being changed. More specifically, the session of the second user's access to the first restricted entity is explicitly authorized. For example, an authorization entity of a type that would become apparent to one of ordinary skill in the art may be added to metadata associated with the second authentication entity and/or a user device being used for the session of the second user's access to explicitly detail this authorization. Furthermore, in response to such a determination the session of the second user's access to the first restricted entity is, in some approaches, terminated upon completion of the second user's query.

In the determination of whether or not to terminate a session, a determination may, in some approaches, additionally and/or alternatively be made as to whether a query that is being performed by a user is listed in the privileged list of queries and/or operations, e.g., see decision 214. This list may, in some approaches, be stored in a configuration file associated with the first restricted entity. For example, where a user device of a second user is determined to be performing a query at the time that the second authentication entity is changed, a determination may be made as to whether the second user's query is listed in the privileged list of queries and/or operations. Similarly, where a user device of a first user is determined to be performing a query at the time that the first authentication entity is changed, a determination may be made as to whether the first user's query is listed in the privileged list of queries and/or operations.

The privileged list of queries and/or operations may, in some approaches, specify types of operations that do not amend data of the first restricted entity. For example, in one or more of such approaches, the privileged list of queries and/or operations may include read operations, but not include data changing operations, e.g., writing data, deleting data, modifying and/or amending data, etc. In such approaches, provided that the user query does not involve a data changing operation the query may be allowed to be performed before terminating the session. However, in response to a determination that the query (that originally was a data read operation) attempts to begin a data changing operation, the session is preferably terminated. The privileged list of queries and/or operations may additionally and/or alternatively specify specific queries that are to be allowed to be performed before terminating a session. These queries may be identified by metadata identifier that are unique to each of these queries, which may be extracted from the metadata and added to the privileged list of queries and/or operations to enrich the privileged list of queries and/or operations.

In some approaches, user queries that are determined to not be listed in the privileged list of queries and/or operations, e.g., as illustrated by the “NO” logical path of decision 214, are not allowed to be performed and associated sessions are preferably terminated, e.g., see operation 216. For example, in response to a determination that the second user's query is not listed in the privileged list of queries and/or operations, in some approaches, method 200 includes not allowing the second user's query to be completed and terminating the session of the second user's access. In contrast, in some approaches, user queries that are determined to be listed in the privileged list of queries and/or operations, e.g., as illustrated by the “YES” logical path of decision 214, are allowed to be performed and associated sessions are preferably not terminated (at least until the query completes), e.g., see operation 218. For example, in response to a determination that the second user's query is listed in the privileged list of queries and/or operations, method 200, in some approaches, includes allowing the second user's query to be completed and terminating the session of the second user's access to the first restricted entity upon completion of the second user's query.

Subsequent to one or more of the authentication entities being changed, method 200 may include enforcing the new authentication entity (enforcing a reauthentication). For example, some approaches below may be based on the first authentication entity being changed to a third authentication entity, and the second authentication entity being changed to a fourth authentication entity. In such approaches, in response to a determination that, subsequent to terminating the session of the first user's access to the first restricted entity, the third authentication entity may be received from a first user device requesting access to the first restricted entity. For example, the third authentication entity may be entered into an authentication bar of an application used to control access to the first restricted entity. In response to receiving the third authentication entity, the first user device is allowed to access the first restricted entity. Furthermore, in some approaches, in response to a determination that, subsequent to terminating the session of the second user's access to the first restricted entity, the fourth authentication entity is received from a second user device requesting access to the first restricted entity, the second user device may be allowed to access the first restricted entity.

In some approaches, the operations of method 200 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to change authentication entities and based on the changes, manage active user access of a restricted entity. Initial training may include reward feedback that may, in some approaches, be implemented using a subject matter expert (SME). However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 200 may be performed. In some further approaches, the AI model may be a neuromyotonic AI model that may improve performance of computer devices in an infrastructure associated with a restricted entity, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from users that use user devices to access the restricted entity. Such an AI model ensures that security of the restricted entity is ensured, where the scale of such analysis and determinations would not otherwise be feasible for a human to perform. This is because humans are not able to efficiently manage such an extent of active sessions, and would otherwise incorporate processing delays and errors in the management of active sessions in the process of attempting to do so. Accordingly, management of operations described herein is not able to be achieved by human manual actions.

In some further approaches, the AI models described above may be deployed to consume historical log data of a company (stored on a server of the company) to determine how to build the lists described herein and perform the operations described herein, e.g., the output of the AI model includes commands to execute operation(s) described herein.

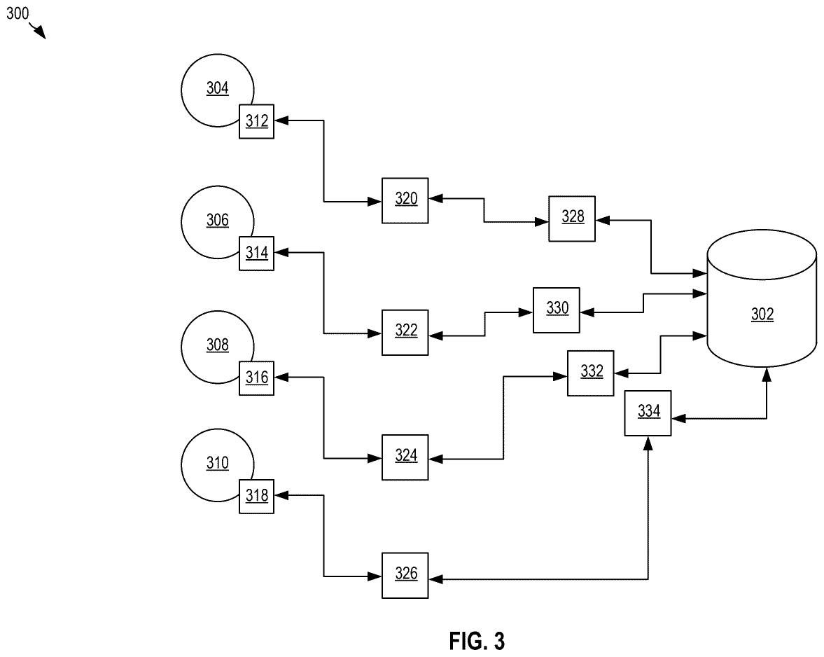

FIG. 3 depicts a network environment 300, in accordance with one embodiment. As an option, the present network environment 300 may be implemented in conjunction with features from any other embodiment listed herein, such as those described with reference to the other FIGS. Of course, however, such network environment 300 and others presented herein may be used in various applications and/or in permutations which may or may not be specifically described in the illustrative embodiments listed herein. Further, the network environment 300 presented herein may be used in any desired environment.

The network environment 300 includes a restricted entity 302 (a database), and a plurality of user devices 304, 306, 308 and 310 that selectively use authentication entities to access the restricted entity. For example, the user devices may perform transaction operations 312, 314, 316 and 318 that include entering current authentication entities in order to access and query the restricted entity. The network environment, in some approaches, implements a Relational Database Management System (RDMS).

As mentioned elsewhere above in method 200, the authentication entities may be changed at any time, for one reason or another. In some approaches, an administrator of the restricted entity may use a user device to create a configuration file which contains parameters that are used to determine how to respond to change(s) made to one or more or the authentication entities, e.g., see entries 320, 322, 324 and 326 which may be specific to users of the different user devices. For example, the configuration file may include a privileged list of queries and/or operations that can possibly be run on the restricted entity. This list details queries and/or operations that are considered to be important enough that when they start running, they should be allowed to run until completion rather than being terminated based on the changes being made to the authentication entities. The configuration file, in some approaches, may additionally and/or alternatively include a privileged list of database users and/or roles that are considered to have a relatively high priority. More specifically, these database users and/or roles are, based on their listing, highly prioritized to an extent that once such users and/or roles begin running a query and/or operation, the query and/or operation are allowed to be run until completion (rather than being terminated early).

The configuration file mentioned above may be checked, e.g., by using a database engine, in response to a determination that an authentical entity is changed. For purposes of an example, an assumption may be made that the authentication entity changes that have occurred include a first authentication entity (associated with user device 304 accessing the restricted entity) is changed to a third authentication entity, a second authentication entity (associated with user device 306 accessing the restricted entity) is changed to a third authentication entity. At the time that these changes are made to the authentication entities, it may be assumed that the user device 304 is connected to the restricted entity and is not running any query, and the user device 306 is connected to the restricted entity and is running a query.

Once the password changes are made, each user device may be checked against the configuration file to see whether or not the user device should have their session immediately terminated or not, e.g., see session termination determinations 328, 330, 332 and 334. Although these changes may be part of a routine password change in which all of the user devices have their authentication entities changed, various operations are described below with respect to the user device 304 and the user device 306. In other words, operations described herein may, in some approaches, be performed with respect to all of the user devices of the network environment. For example, a session of the user device 304 may be terminated in response to a determination that the user device is not currently running any query. In contrast, for a session of the user device 306 that includes a query being run at the time the change is performed, a first check procedure may be performed. The first check procedure, in some approaches, includes checking whether a user associated with the user device 306 is included in the privileged list of database users and/or roles. In response to a determination that the user is included in the list, the session of the user device 306 is allowed to continue until the query is completed. Thereafter the session is terminated in response to a determination that the query completes. In contrast, in response to a determination that the user is not included in the list, a second check procedure may be performed. The second check procedure may include determining whether the user device 306 is currently running a query's base format/structure/operations are on the privileged list of queries and/or operations. In response to a determination that the user device is not currently running a query's base format/structure/operations included in the privileged list of queries and/or operations, the session of the user device 306 is immediately terminated. In contrast, in response to a determination that the user device is currently running a query's base format/structure/operations included in the privileged list of queries and/or operations, the session of the user device 306 is allowed to continue until the query is completed. Thereafter the session is terminated in response to a determination that the query completes.

In some approaches, the techniques described herein may additionally and/or alternatively apply to a use case scenario in which an administrator of the restricted entity needs to drop a user that is currently using a user device that is currently connected to the restricted entity and possibly currently running a query. The techniques described herein may be modified to decide whether the user session should be immediately terminated (to thereby drop the user from the restricted entity, or whether the user device should be allowed to continue to complete the current query (and thereafter terminate the session and drop the user in response to a determination that the query has been completed).

In some approaches, the restricted entity is a database that is configured for transactional commits of a type that would become apparent to one of ordinary skill in the art after reading the descriptions herein. This allows the session transaction to be rolled back in response to a determination being made to terminate a running transaction of a user device.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
changing a first authentication entity associated with a first user's access to a first restricted entity and a second authentication entity associated with a second user's access to the first restricted entity;
in response to a determination that the first user's access to the first restricted entity includes the first user not currently running a query, terminating a session of the first user's access to the first restricted entity based on the first authentication entity being changed;
in response to a determination that the second user's access to the first restricted entity includes the second user currently running a query, determining whether the second user is listed in a privileged list of users and/or roles; and
in response to a determination that the second user is listed in the privileged list of users and/or roles: allowing a session of the second user's access to the first restricted entity to continue, and terminating the session of the second user's access to the first restricted entity upon completion of the second user's query.

2. The method of claim 1, further comprising:
in response to a determination that the second user is not listed in the privileged list of users and/or roles, terminating the session of the second user's access to the first restricted entity based on the second authentication entity being changed.

3. The method of claim 1, further comprising:
determining whether the second user's query is listed in a privileged list of queries and/or operations; and
in response to a determination that the second user's query is listed in the privileged list of queries and/or operations: allowing the second user's query to be completed and terminating the session of the second user's access to the first restricted entity upon completion of the second user's query.

4. The method of claim 3, further comprising:
in response to a determination that the second user's query is not listed in the privileged list of queries and/or operations: not allowing the second user's query to be completed and terminating the session of the second user's access.

5. The method of claim 1, further comprising:
listing the first user in the privileged list of users and/or roles;
in response to a determination that the first user performs an action listed in a restricted list of risky user behaviors, adding to a count; and
in response to a determination that a value of the count exceeds a predetermined threshold, removing the first user from being listed in the privileged list of users and/or roles.

6. The method of claim 5, wherein the action listed in the restricted list of risky user behaviors is selected from the group consisting of: using a work device for personal use, using the work device on an unsecure network, storing the first authentication entity in a file without password protection, and failing to correctly enter the first authentication entity while attempting to initiate the session of the first user's access to the first restricted entity.

7. The method of claim 1, wherein the first authentication entity is changed to a third authentication entity, wherein the second authentication entity is changed to a fourth authentication entity, and further comprising:
in response to a determination that, subsequent to terminating the session of the first user's access to the first restricted entity, the third authentication entity is received from a first user device requesting access to the first restricted entity, allowing the first user device to access to the first restricted entity; and
in response to a determination that, subsequent to terminating the session of the second user's access to the first restricted entity, the fourth authentication entity is received from a second user device requesting access to the first restricted entity, allowing the second user device to access to the first restricted entity.

8. The method of claim 1, wherein the first restricted entity is selected from the group consisting of: a data lake, a database, a document, an index, an application, and a server, wherein the first authentication entity and the second authentication entity are selected from the group consisting of: a password, a token and a key.

9. The method of claim 1, wherein a first user device of the first user is connected to the first restricted entity and not running a query during the changing of the first authentication entity, wherein a second user device of the second user is connected to the first restricted entity and running a query during the changing of the second authentication entity.

10. A computer program product comprising:
one or more computer readable storage media; and
program instructions stored on the one or more storage media to perform operations comprising:
changing a first authentication entity associated with a first user's access to a first restricted entity and a second authentication entity associated with a second user's access to the first restricted entity;
in response to a determination that the first user's access to the first restricted entity includes the first user not currently running a query, terminating a session of the first user's access to the first restricted entity based on the first authentication entity being changed;
in response to a determination that the second user's access to the first restricted entity includes the second user currently running a query, determining whether the second user is listed in a privileged list of users and/or roles; and
in response to a determination that the second user is listed in the privileged list of users and/or roles: allowing a session of the second user's access to the first restricted entity to continue, and terminating the session of the second user's access to the first restricted entity upon completion of the second user's query.

11. The computer program product of claim 10, wherein the operations further
comprise:
in response to a determination that the second user is not listed in the privileged list of users and/or roles, terminating the session of the second user's access to the first restricted entity based on the second authentication entity being changed.

12. The computer program product of claim 10, wherein the operations further comprise:
determining whether the second user's query is listed in a privileged list of queries and/or operations; and
in response to a determination that the second user's query is listed in the privileged list of queries and/or operations: allowing the second user's query to be completed and terminating the session of the second user's access to the first restricted entity upon completion of the second user's query.

13. The computer program product of claim 12, wherein the operations further comprise:
in response to a determination that the second user's query is not listed in the privileged list of queries and/or operations: not allowing the second user's query to be completed and terminating the session of the second user's access.

14. The computer program product of claim 10, wherein the operations further comprise:
listing the first user in the privileged list of users and/or roles;
in response to a determination that the first user performs an action listed in a restricted list of risky user behaviors, adding to a count; and
in response to a determination that a value of the count exceeds a predetermined threshold, removing the first user from being listed in the privileged list of users and/or roles.

15. The computer program product of claim 14, wherein the action listed in the restricted list of risky user behaviors is selected from the group consisting of: using a work device for personal use, using the work device on an unsecure network, storing the first authentication entity in a file without password protection, and failing to correctly enter the first authentication entity while attempting to initiate the session of the first user's access to the first restricted entity.

16. The computer program product of claim 10, wherein the first authentication entity is changed to a third authentication entity, wherein the second authentication entity is changed to a fourth authentication entity, wherein the operations further comprise:
in response to a determination that, subsequent to terminating the session of the first user's access to the first restricted entity, the third authentication entity is received from a first user device requesting access to the first restricted entity, allowing the first user device to access to the first restricted entity; and
in response to a determination that, subsequent to terminating the session of the second user's access to the first restricted entity, the fourth authentication entity is received from a second user device requesting access to the first restricted entity, allowing the second user device to access to the first restricted entity.

17. The computer program product of claim 10, wherein the first restricted entity is selected from the group consisting of: a data lake, a database, a document, an index, an application, and a server, wherein the first authentication entity and the second authentication entity are selected from the group consisting of: a password, a token and a key.

18. The computer program product of claim 10, wherein a first user device of the first user is connected to the first restricted entity and not running a query during the changing of the first authentication entity, wherein a second user device of the second user is connected to the first restricted entity and running a query during the changing of the second authentication entity.

19. A computer system comprising:
a processor set;
one or more computer readable storage media; and
program instructions stored on the one or more storage media to cause the processor set to perform operations comprising:
changing a first authentication entity associated with a first user's access to a first restricted entity and a second authentication entity associated with a second user's access to the first restricted entity;
in response to a determination that the first user's access to the first restricted entity includes the first user not currently running a query, terminating a session of the first user's access to the first restricted entity based on the first authentication entity being changed;
in response to a determination that the second user's access to the first restricted entity includes the second user currently running a query, determining whether the second user is listed in a privileged list of users and/or roles; and
in response to a determination that the second user is listed in the privileged list of users and/or roles: allowing a session of the second user's access to the first restricted entity to continue, and terminating the session of the second user's access to the first restricted entity upon completion of the second user's query.

20. The computer system of claim 19, wherein the operations further comprise:
in response to a determination that the second user is not listed in the privileged list of users and/or roles, terminating the session of the second user's access to the first restricted entity based on the second authentication entity being changed.
